(19) United States
(12) Patent Application Publication
(10) Pub. No.: US 2008/0049110 A1
(43) Pub. Date: Feb. 28, 2008

(54) Universal Remote Control Digital Cameras

(76) Inventor: Ivan Arbouzov, Arlington, TX (US)

Correspondence Address: Rudolf O. Siegesmund;Gordon & Rees LLP, Suite 2650, 2100 Ross Avenue, Dallas, TX, 75201, US

(21) Appl. No.: 11/467,021

(22) Filed: Aug. 24, 2006

(51) Int. Cl. H04N 5/232

(52) U.S. Cl. 348/211.99

(57) ABSTRACT

The “Universal Digital Camera Remote Control” (“UDCRC”) allows users to add a remote control to any camera having an interface port. The UDCRC comprises an adapter unit that connects to the interface port of the digital camera, and a remote unit that communicates with the adapter unit. Controls on the remote unit correspond to various functions of the digital camera so that when a user selects and activates one of the controls on the remote unit, a signal corresponding to the control selected is sent to the adapter unit. The adapter unit detects the signal and sends a corresponding command to the digital camera via the interface port so that the digital camera performs the function corresponding to the control selected by the user.

### FIELD OF THE INVENTION

The present invention relates to digital cameras and relates specifically to remotely controlling a digital camera.

### BACKGROUND OF THE INVENTION

Since the invention of the camera, users have looked for ways to remotely activate a camera's shutter. One innovation involved mechanical shutter cables. Mechanical shutter cables allow a user to reduce shaking of a camera while activating the shutter. While mechanical shutter cables allow users to step away from the camera and still take a picture, the length of the cable limits the standoff distance from the camera. Although some contemporary cameras still use mechanical shutter cables, most modern cameras are compact models not adapted to use shutter cables. Another innovation involved mechanical and electronic timers. Mechanical and electronic timers allow users to set a time interval for the camera shutters so that the user can step away and be in the picture.

Electronic timers are a common feature on modern compact film and digital cameras. Additionally, most modern compact digital cameras employ one or more interface ports to facilitate communication with an outside device such as a computer or printer. Common standards for interface ports are USB, MINI USB, and FIREWIRE. Computers and printers can download saved content from a digital camera via an interface port, and can control functions of the digital camera such as resizing, cropping, adjusting image settings, and taking a picture. Methods for communicating with and controlling a digital camera via an interface port are known in the art.

Some camera manufacturers integrate remote controls into one or more of their digital camera models. Integrated remote controls are also commonly supplied with compact digital video cameras. The digital camera models with integrated remote controls allow users to manipulate the camera's controls from a distance using a separate remote control unit. U.S. Pat. No. 6,262,767, and U.S. Pat. No. 5,260,795 disclose compact digital cameras with integrated remote controls. Remotely controlled cameras generally have an integrated infrared (IR) receiver built into the main body of the camera. A separate remote control unit has actuators so that the user can control various functions of the camera by selecting and activating one of the actuators to cause the remote control unit to send an IR signal to the IR receiver. The IR receiver then causes the camera to perform the desired function.

Remote controls for cameras work much like the remote controls used for controlling televisions, VCRs, and DVD players. In addition to IR signals, remote controls sometimes use radio waves from the FM, UHF, and other frequency bands. Remote controls provide the user flexibility in digital camera placement, because the user does not have to physically touch the camera to perform functions such as zooming, adjusting focus, or activating the shutter. Remote controls also allow users to avoid time constraints inherent to using an automatic timer.

Remote controls are not, however, commonly found on compact digital cameras. If a digital camera comes with a remote control, the remote control mechanism is integrated with the digital camera, and cannot be removed or used on a different digital camera. All digital camera, whether with an integrated remote control or without an integrated remote control, have an interface port. A need exists for a remote control that can be added to a digital camera using the interface port.

### SUMMARY OF THE INVENTION

The “Universal Digital Camera Remote Control” (“UDCRC”) allows users to add remote control functionality to any digital camera that has an interface port. The UDCRC comprises an adapter unit and a remote unit. The adapter unit connects to the interface port of a digital camera and receives signals from the remote unit. The remote unit has actuators, corresponding to various functions of the digital camera, and a transmitter. When a user selects and activates an actuator on the remote unit, the remote unit sends a signal to the adapter unit. The adapter unit detects the signal and sends a corresponding command to the digital camera via the interface port.

The UDCRC further comprises one or more programs that may be described as an initialization component, a transmission component and a reception component. The initialization component resides in the memory of the adapter unit and identifies the attached camera model to ensure the proper instruction set is used to control the camera's functions. The transmission component resides in the memory of the remote unit and sends a signal corresponding to the actuator of the remote unit selected and activated by a user. The reception component resides in the memory of the adapter unit and detects signals from the remote unit and sends a corresponding command to the camera via the interface port.

In an alternate embodiment of the UDCRC, the remote is connected by a cable to the digital camera's interface port. In the alternate embodiment of the UDCRC, the initialization component and the reception component reside in the memory of the remote unit.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1A is an exemplary camera and Universal Digital Camera Remote Control;

FIG. 1B shows an adapter unit mated to a camera;

FIG. 1C shows a connector of the first adapter unit in a closed position;

FIG. 1D shows a connector of the first adapter unit in an open position;

FIG. 1E shows a first alternate adapter unit;

FIG. 1F shows a second alternate adapter unit;

FIG. 1G shows a third alternate adapter unit;

FIG. 1H shows three alternate connector configurations;

FIG. 1I shows functional elements of the adapter unit and the remote unit;

FIG. 2 shows programs and files in a representation of a memory containing components of the adapter unit and the remote unit;

FIG. 3 depicts a flowchart of the initialization component process;

FIG. 4 depicts a flowchart of the transmission component process;

FIG. 5 depicts a flowchart of the reception component process;

FIG. 6 depicts an alternate remote unit;

FIG. 7 depicts functional elements of the alternate remote unit;

FIG. 8 depicts programs and files in a representation of a camera memory and an alternate remote unit memory.

### DETAILED DESCRIPTION OF THE PREFERRED EMBODIMENT

The principles of the UDCRC are applicable to a variety of digital camera hardware and software configurations used to control the functions of digital cameras. The term digital camera means any machine or apparatus that is capable of recording photographic images on an electronic medium as data, and that is also capable of accepting data, performing logic operations on data, storing data, or displaying data, and includes without limitation a housing, a lens, a power supply, a motor, a processor, and a memory. The term memory means any physical, optical, electromagnetic, or other medium through which electronic data (including instructions) can be stored. The term program means any set of logical instructions in a memory operable to cause a digital camera, an adapter unit, or a remote unit to perform an operation or function, and a program may be software running on a programmable processor, such as a general purpose processor or a digital signal processor (DSP), or it may be hard-wired instructions that are part of the hardware in an application specific integrated circuit (ASIC), or it may be an integrated circuit that can be reprogrammed by burning a new program onto a rewritable persistent memory or floating gate, transistor array to reconfigure the integrated circuit hardware, or it may be another embodiment of a program known in the art.

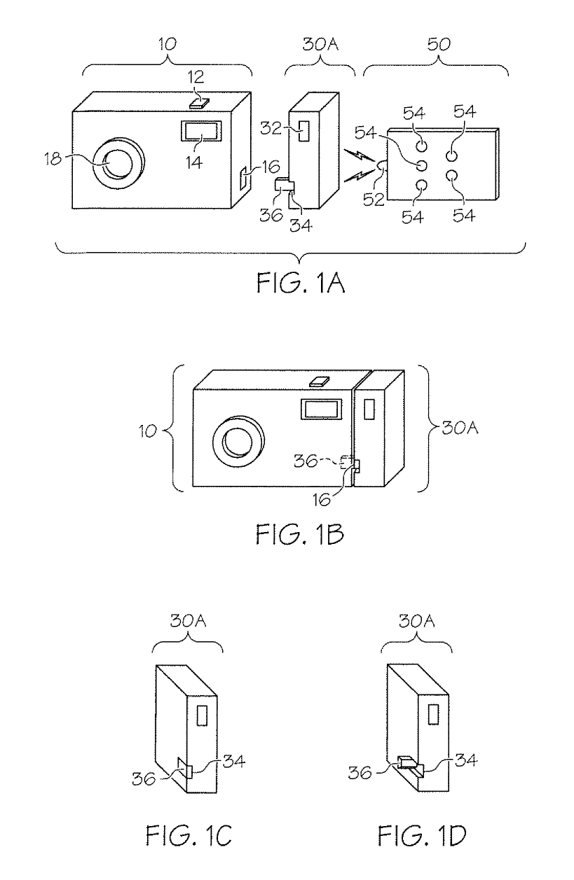

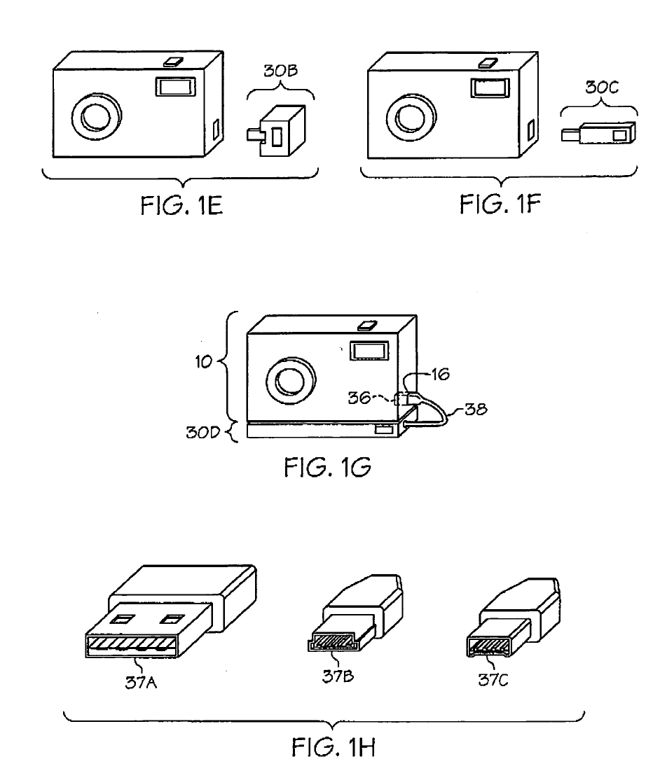

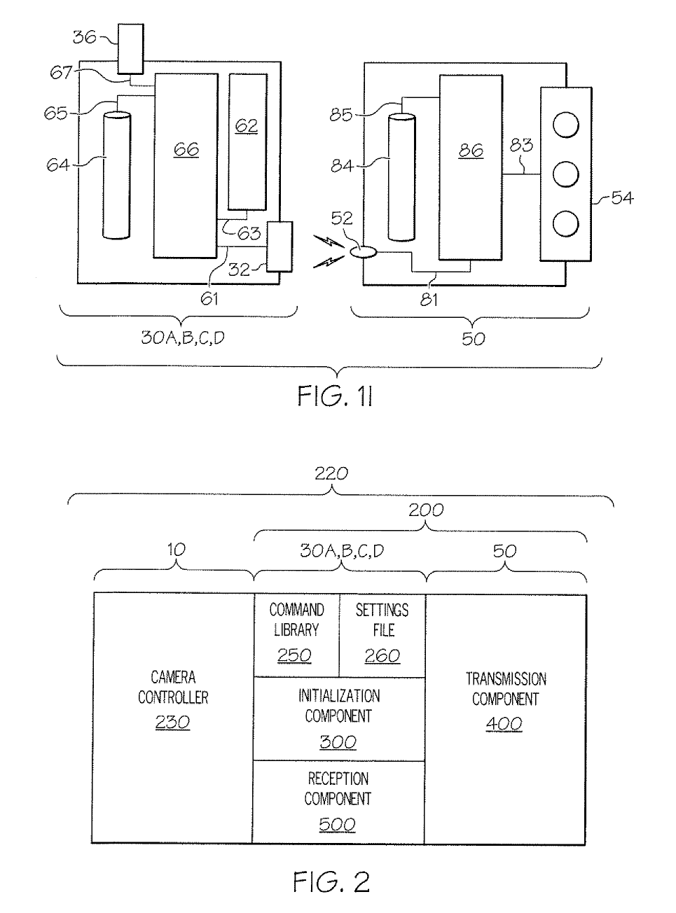

Additionally, the UDCRC is described below with reference to an exemplary combination of hardware devices, as depicted in FIG. 1A, comprising digital camera 10, adapter unit 30A and remote unit 50. Digital camera 10 is shown with shutter actuator 12, flash 14, lens 18 and interface port 16. Adapter unit 30A is shown with detector 32, indentation 34 and interface connector 36. Interface connecter 36 on adapter unit 30A is configured to engage interface port 16 on camera 10. Remote unit 50 is shown with a plurality of actuators 54 and emitter 52. In a preferred embodiment, emitter 52 and detector 32 use infrared (IR) signals, but other signals known in the art can be used, such as radio waves or optical waves at wavelengths other than IR.

FIG. 1B shows adapter unit 30A mated to digital camera 10 with interface connector 36 inserted into interface port 16. In one embodiment of the UDCRC, interface connector 36 is mounted to adapter unit 30A on a hinge so that interface connector 36 closes into indention 34 for storage in adapter unit 30A as shown by FIG. 1C. When needed, interface connector 36 rotates outward from indention 34 as shown in FIG. 1D to allow adapter 30A to engage with interface port 16 on digital camera 10.

Digital camera 10, adapter unit 30A, and remote unit 50 are not limited to the shapes and configurations shown in FIG. 1A through FIG. 1D. For example, FIG. 1E shows first alternate adapter unit 30B which is a compact version of adapter unit 30A. FIG. 1F shows second alternate adapter unit 30C which is a miniature version of adapter unit 30A. FIG. 1G shows third alternate adapter unit 30D that attaches underneath digital camera 10. In the embodiment of third alternate adapter unit 30D, interface connector 36 is located at a first end of cable 38, and is adapted to engage interface port 16 while third alternate adapter unit 30D is connected to the bottom of digital camera 10. Further, in the embodiment of third alternate adapter unit 30D, the second end of cable 38 can be permanently affixed to third alternate adapter unit 30D or the second end of cable 38 can be removably engaged to an interface port on third alternate adapter 30D (not shown).

Because interface port 16 on digital camera 10 may be positioned in other locations than the side, other configurations of adapter 30A, first alternate adapter 30B, second alternate adapter 30C, and third alternate adapter 30D, known to persons skilled in the art, can be adapted for mating with digital camera 10 at any location at which an interface port such as interface port 16 may be situated on a digital camera such as digital camera 10, and an interface connector such as interface connector 36 may be situated on adapter unit configurations 30A through 30D, or any other such configuration known to persons skilled in the art, to accommodate such alternate configurations of digital camera 10 (not shown). An embodiment of adapter unit 30A using a removable embodiment of cable 38 can be used to change interface connecter 36 to a different type of interface connector. For example, interface connector 36 may be configured for connection to an interface port that provides a USB connection and the configuration of interface connector 36 may be changed to a FIREWIRE connection. FIG. 1H shows three possible embodiments of interface connector 36. First connector 37A is a standard USB-A connector. Second connector 37B is a MIN-USB connector. Third connector 37C is a MINI-FIREWIRE connector. A further embodiment of adapter unit 30A (not shown) has more than one interface connector, each adapted to fit different interface port types.

Although in the preferred embodiment, adapter unit 30A is sufficiently small and lightweight to be supported solely by the interface connector 36 engaged with port 16, alternate embodiments may employ additional attachments to secure adapter 30A to digital camera 10. Alternate attachments include, but are not limited, to hook and loop fasteners affixed to the body of digital camera 10 and adapter unit 30 by adhesive. Other attachment methods include elastic loops and adjustable straps or clips affixed to adapter unit 30 and adapted to fit around or over the edges of digital camera 10. An alternate embodiment of adapter unit 30 attaches to a tripod mount on the bottom of camera 10 (not shown), and has an additional tripod mount underneath adapter unit 30 (not shown) for mounting the entire assembly of adapter unit 30 and digital camera 10 to a tripod (not shown). Further, adapter unit 30 and remote unit 50 may have lanyards or belt clips to facilitate transportation. In an alternate embodiment, adapter unit 30 may be contained within a camera case (not shown), and remote unit 50 may be attached to the camera case when remote unit 50 is not in use, and remote unit 50 may be detached from the camera case for use when needed. In addition, adapter units such as adapter units 30A-D may be attached to an additional lens or additional optics and affixed to camera 10 by affixing the additional lens or optics to the camera (not shown).

Remote unit 50 requires a power source (not shown), such as a replaceable or rechargeable battery. Adapter unit 30 may have an internal power source, or adapter unit 30 can draw power from digital camera 10 through interface connector 36 or by connection to a power outlet on digital camera 10 (not shown). FIG. 1I shows the functional elements of adapter unit 30 and remote unit 50. Adapter logic 66 comprises a processor and other hardware necessary to manage and facilitate communication with the other functional elements of adapter units 30A-D. Signals received by detector 32 are transmitted to adapter logic 66 via connection 61. Memory 62 can be accessed by adapter logic 66 via connection 63. Internal power source 64 supplies power to adapter logic 66 via connector 65. Connector 67 links adapter logic 66 to interface connector 36 to facilitate communication with digital camera 10. Remote logic 86 comprises a processor and other hardware necessary to manage and facilitate communication with the other functional elements of remote unit 50. Actuator 54 interfaces with remote logic 86 via connector 83. Internal power source 84 supplies power to remote logic 86 via connector 85. Connector 81 links remote logic 86 with emitter 52 for sending signals to adapter unit 30. Moreover, adapter unit 30 and remote unit 50 may be solar powered, or may contain batteries that can be recharged by solar cells or photoelectric cells affixed to or built into adapter unit 30 and built into remote unit 50 so that each has a self-charging capability. In one embodiment, power is supplied by two AAA batteries and the battery compartment is approximately two and one-half inches by one and one-half inches. Further embodiments of adapter unit 30 and remote unit 50 have power on and power off switches (not shown). In an alternate embodiment of the UDCRC, remote unit 50 has an LCD display and controls that allows a user to navigate the menu system of digital camera 10, and in this embodiment adapter unit 30 and remote unit 50 each have both transmission and reception capability.

UDCRC 200 typically is stored in a memory, represented schematically as memory 220 in FIG. 2. Memory 220 may encompass and be distributed across a plurality of media. Further, UDCRC 200 may reside in more than one memory distributed across different electronic components. The components depicted in memory 220 may be located in or distributed across separate memories in any combination, and UDCRC 200 may be adapted to identify, locate, and access any of the components and coordinate actions, if any, by the distributed components. Thus, FIG. 2 is included merely as a descriptive expedient and does not necessarily reflect any particular physical embodiment of memory 220. As depicted in FIG. 2, though, memory 220 may include additional data and programs. Of particular import to UDCRC 200, memory 220 may include camera controller 230, a program that controls the functions of digital camera 10 with which UDCRC 200 interacts. Camera controller 230 may be a camera specific protocol provided by the manufacturer of camera 10, or it may be a program specially created for a particular model of digital camera 10 by the manufacturer of UDCRC 200. Camera controller 230 may include additional protocols for connection protocols for port 16. For example, RS232 may be used as a serial connection protocol. UDCRC 200 has initialization component 300, transmission component 400 and reception component 500. Initialization component 300 and reception component 500 are part of adapter unit 30. Command library 250 and settings file 260 are data files on adapter unit 30 with which initialization component 300 and reception component 500 interact. Transmission component 400 is part of remote unit 50. The functions of the logical components of UDCRC 200 are described in further detail below.

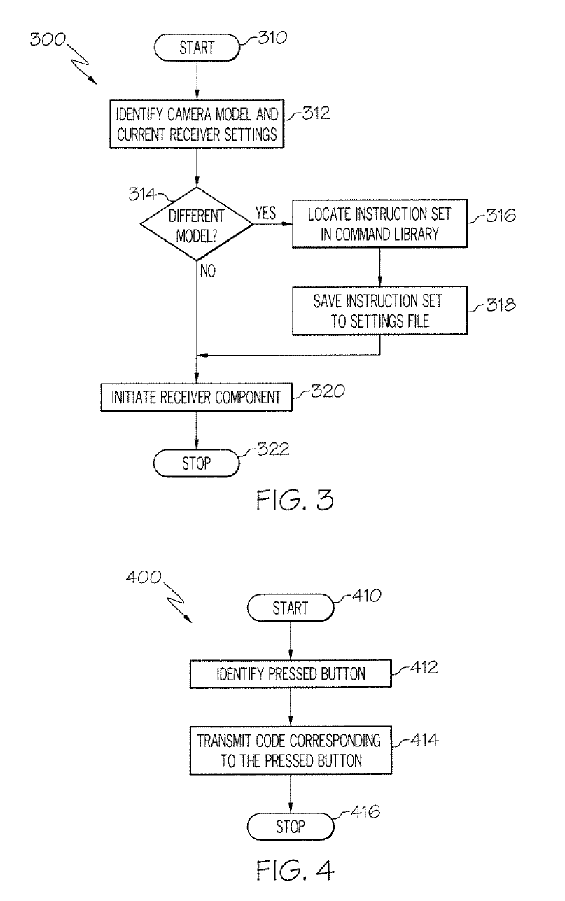

FIG. 3 depicts initialization component 300. Initialization component 300 starts whenever adapter unit 30 mates with digital camera 10, and digital camera 10 is turned on (310). Initialization component 300 identifies the manufacturer and model of digital camera 10, and identifies the current adapter settings in settings file 260 (312). If the current settings in settings file 260 do not match the particular model of digital camera 10 (314), initialization component 300 locates the proper instruction set for controlling digital camera 10 in command library 250 (316). Initialization component 300 saves the proper instruction set and model of digital camera 10 to settings file 260 (318). Initialization component 300 initiates adapter component 500 (320) and stops (322). Other functions of initialization component 300, not shown here, include communication with a general purpose computer via interface connector 36 to update command library 250.

FIG. 4 depicts transmission component 400. Transmission component 400 starts whenever an actuator on remote unit 50 is selected and activated by a user (410). Transmission component 400 identifies the selected actuator (412), transmits a signal with a code corresponding to the selected actuator (414) and stops (416). Remote unit 50 has at least one actuator to cause digital camera 10 to activate the shutter. Remote unit 50 may have additional actuators corresponding to additional functions such as adjusting image magnification (zoom) and adjusting flash settings.

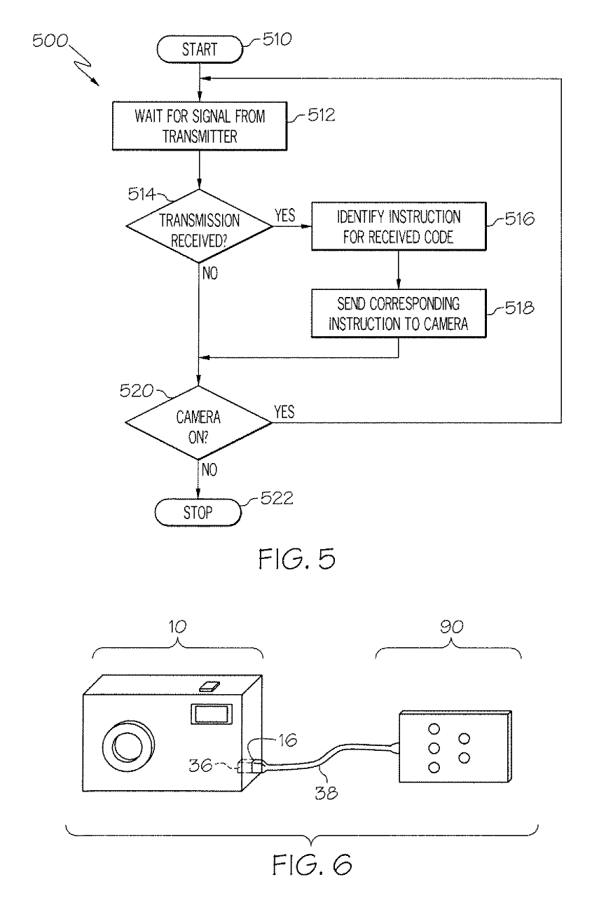

FIG. 5 depicts reception component 500. Reception component 500 starts when initialized by initialization component 300 (510). Reception component 500 waits for a signal containing a code from remote 50 (512). Whenever reception component 500 receives a signal (514), reception component 500 interprets the received code (516) and sends the corresponding instruction from settings file 260 to camera 10 (518). For as long as camera 10 remains on, reception component 500 repeats steps 512-518 (520). Whenever camera 10 turns of, reception component 500 turns off (522).

FIG. 6 depicts alternate remote unit 90 connected by cable 38 to digital camera 10 via interface port 16. As will be discussed below, alternate remote unit 90 contains components of adapter units 30A-D so that all that is necessary for remote operation is to insert interface connector 36 into interface port 16.

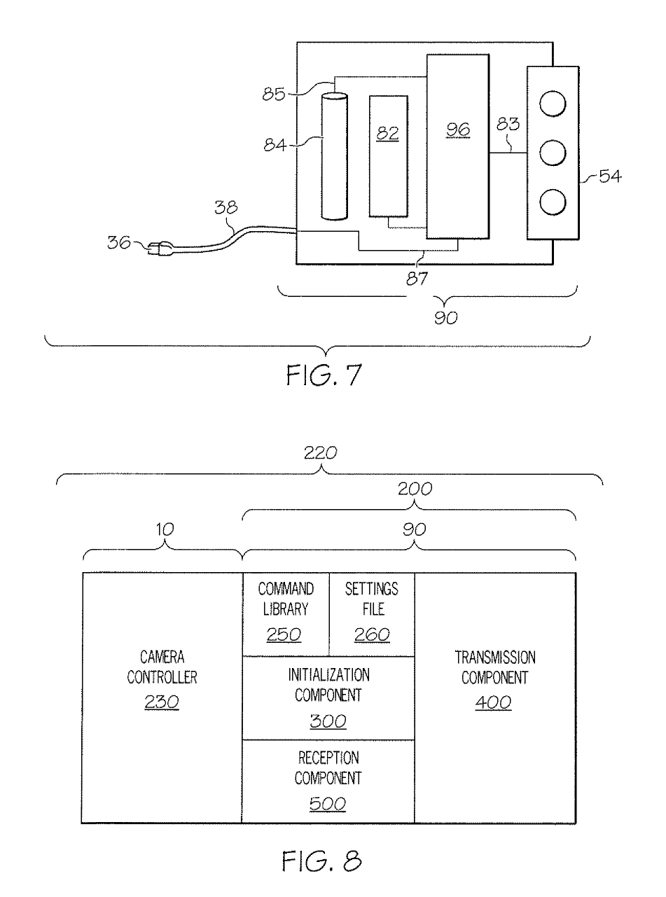

FIG. 7 depicts alternate remote unit 90. Alternate remote unit 90 has remote logic 96, actuator 54, and connector 83. Remote logic 96 comprises a processor and other hardware necessary to manage and facilitate communication with the other functional elements of alternate remote control 90. Actuator 54 interfaces with remote logic 96 via connector 83. Internal power source 84 supplies power to remote logic 96 via connector 85. Connector 87 links remote logic 96 with cable 38, and in turn, cable 38 is connected to interface connector 36. Interface connector 36 is adapted for connection to adapter unit 30 for sending commands to digital camera 10 (not shown).

FIG. 8 depicts memory 220 configured for alternate remote unit 90. UDCRC 200 typically is stored in a memory, represented schematically as memory 220 in FIG. 8. The components depicted in memory 220 may be located in or distributed across separate memories in any combination, and UDCRC 200 may be adapted to identify, locate and access any of the components and coordinate actions, if any, by the distributed components. Thus, FIG. 8 is included merely as a descriptive expedient and does not necessarily reflect any particular physical embodiment of memory 220. Alternate remote unit 90 has initialization component 300, transmission component 400, reception component 500, command library 250. settings file 260 (data files with which initialization component 300 and reception component 500 interact), and transmission component 400. In other words, the necessary functions of the adapter unit and of the remote unit have been combined in alternate remote unit 90.

In alternate embodiments of UDCRC 200 (not shown), adapter unit 30A-30D, remote unit 50, and alternate remote unit 90 may be modified to add additional functionality so that remote unit 50 or alternate remote unit 90 may be operated without user selection of an actuator. In such embodiments actuators may be activated by one or more automatic triggering devices based upon sound, light, or pressure activation. For example, a laser signal may be aimed from remote unit 50 or alternate remote unit 90 so that digital camera 10 will take a picture when an object moves into the path of the laser. In the same manner, sensors located at remote unit 50 or alternate remote unit 90 could cause digital camera 10 to take a picture when light intensity reached a user selected level. In like manner, pressure sensors could be used to cause digital camera 10 to take a picture when activated by a pressure sensitive pad placed on the ground (not shown) and connected to remote unit 50 or alternate remote unit 90, or changes in atmospheric pressure could be used to cause digital camera 10 to take a picture with an atmospheric pressure trigger (not shown). Such sensors could be built into remote unit 50 or alternate remote unit 90, or such sensors could be attached to remote unit 50 or to alternate remote unit 90 by connection to an interface port on remote unit 50 or alternate remote unit 90. Persons skilled in the art will realize the advantages for wildlife and nature photographers of such a capability and also for security applications.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A method for remotely controlling a digital camera, the process comprising:
connecting an adapter to an interface port on the digital camera so that, responsive to activation of an actuator by a user on a remote and communication of a first signal from the remote that corresponds to the actuator activated by the user, the adapter communicates a second signal to the camera so that the digital camera performs a function corresponding to the actuator on the remote activated by the user.

2. The method of claim 1 wherein the signal comprises an optical wave.

3. The method of claim 1 wherein the signal comprises a radio wave.

4. The method of claim 1 wherein the interface port complies with USB standards.

5. The method of claim 1 wherein the interface port complies with FIREWIRE standards.

6. The method of claim 1 wherein the command directs the controller on the camera to activate the shutter and take a picture.

7. The method of claim 1 wherein the command directs the controller on the camera to adjust magnification of an image to be photographed.

8. The method of claim 1 wherein the command directs the controller on the camera to adjust settings for a flash.

9. An apparatus for remotely controlling a camera, the apparatus comprising:
a remote with at least one actuator corresponding to a function on a camera, adapted to send signals to an adapter;
the adapter adapted to connect to the interface port of a camera and communicate with a controller computer on the camera;
a processor connected to a memory in the adapter;
a program in the memory operable to initialize the adapter to interact with the controller computer on the camera and responsive to a signal sent by the remote, send a command to the controller computer on the camera corresponding to the signal sent by the remote.

10. The apparatus of claim 9 wherein the signal comprises an optical wave.

11. The apparatus of claim 9 wherein the signal comprises a radio wave.

12. The apparatus of claim 9 wherein the interface port complies with USB standards.

13. The apparatus of claim 9 wherein the interface port complies with FIREWIRE standards.

14. The apparatus of claim 9 wherein the command directs the controller computer on the camera to activate the shutter and take a picture.

15. The apparatus of claim 9 wherein the command directs the controller computer on the camera to adjust magnification of an image to be photographed.

16. The apparatus of claim 9 wherein the command directs the controller computer on the camera to adjust settings for a flash.

17. The apparatus of claim 9 wherein the connection between the adapter and the camera's interface port is structurally sufficient to support the weight of the adapter.

18. The apparatus of claim 9 further comprising a mechanical means of attaching the adapter to the camera in addition to the connection through the interface port.

19. The apparatus of claim 9 wherein the adapter is adapted to connect to more than one interface port types.
